(19) United States
(12) Patent Application Publication
(10) Pub. No.: US 2014/0318995 A1
(43) Pub. Date: Oct. 30, 2014

(54) Barrier Element Removal

(71) Applicant: Novo Nordisk Healthcare AG, Zurich (CH)

(72) Inventor: Lars Eilertsen, Fredensborg (DK)

(73) Assignee: NOVO NORDISK HEALTHCARE AG, Zurich (CH)

(21) Appl. No.: 14/359,798

(22) PCT Filed: Nov. 21, 2012
(86) PCT No.: PCT/EP2012/073205

§ 371 Date: May 21, 2014

Related U.S. Application Data
(60) Provisional application No. 61/563,938, filed on Nov. 28, 2011.

(30) Foreign Application Priority Data
Nov. 22, 2011 (EP) 11190060.1

(51) Int. Cl. A61J 1/20

(52) U.S. Cl. CPC A61J 1/2093; A61J 2001/2027
USPC 206/219

(57) ABSTRACT

A medical device (1) comprising a frame (2, 3, 6) defining an interior, a barrier element (58) arranged to fluidly divide at least a portion of the interior, and barrier removal means (30) connected with the barrier element and operable from an exterior of the frame to remove the barrier element from the interior through an opening (99) in the frame.

### FIELD OF THE INVENTION

The present invention relates generally to medical devices and more specifically to such devices incorporating barrier means for fluid division of internal areas.

### BACKGROUND OF THE INVENTION

In connection with the administration, of drugs to subjects, particularly drugs that are to be delivered directly into the bloodstream, it may be of vital importance to ensure that the sterility of the drug is maintained until it reaches the intended target.

Liquid drugs are typically stored in sealed sterile containers and are either administered therefrom or withdrawn therefrom for delivery via an intermediate container. Regardless of which, often a needle element is used to penetrate a sealing septum of the container to enable transfer of the drug out of the container. It is recommended that the exterior surface of the septum is cleaned by the user before needle penetration, e.g. by use of an alcohol swab, to avoid deposition of impurities on the needle. Swabbing is viewed by many as an additional hassle and, accordingly, there is a tendency towards neglecting this step.

Some pharmaceutical drugs adapted for parenteral administration are only stable in the administrable form a relatively short period of time. For convenience reasons, and in order to extend the shelf life of such a drug, it is sometimes preferred to store individual constituents of the drug separately and to mix them only just before a dose is needed.

Traditionally, a mixing of two substances stored in separate vials is performed using a syringe with a needle to withdraw the substance from the one vial and inject it into the other vial. The syringe with the attached needle is then used to withdraw from this vial the desired amount of drug to be injected into the patient. This kind of manual operation may be difficult and may bring about some uncertainty as to the exact concentration of the resulting drug, because it can be difficult to completely empty a vial by such an approach. Moreover, since the first substance is withdrawn from one vial and transported to another vial via a syringe with a needle, typically including a penetration of two rubber septa in order to establish fluid connection to the respective vial interiors, both sterility and safety may be compromised.

Dedicated mixing devices exist, however, which offer fluid transfer between containers without the user having to handle any sharp objects.

WO 97/46203 (Applied Research Systems ARS Holding N.V.), for example, discloses a pre-assembled pack for a drug reconstituting device, which pack comprises a vial co-axially aligned with a cartridge and separated therefrom by a double-ended needle element. In the pre-use state of the device the needle element is shielded at each end by a slidable bung, providing for closed needle chambers. The respective needle elements are adapted to penetrate the bungs before penetrating the vial and cartridge closures.

WO 2009/014955 (Amylin Pharmaceuticals, Inc.) discloses a pen injection device comprising a dual transfer spike assembly adapted for establishing fluid communication between two cartridges. Various embodiments of pierceable separating members arranged at each end of the dual transfer spike assembly, or about each spike, for the purpose of maintaining sterility of the system are presented.

Both of the above mentioned disclosures may provide aseptic, closed environments for the individual needle elements until penetration of the respective container closures. However, there are several drawbacks associated with having to penetrate multiple septa in order to establish fluid communication with a given container. First of all, fragments of material may be torn from a septum when it is pierced, so increasing the number of septa to be pierced adds to the risk of carrying septum fragments into the container. Furthermore, each septum the needle has to penetrate may blunt its cutting edge, whereby the force required to advance the needle into the container will increase.

US 2010/0163439 (Gutierrez Avendano) discloses a mixing device which comprises two containers mechanically joined by a thread interface and fluidly separated by a sheet and a seal. The sheet is removed through an aperture via an exterior pull tab to cause the contents of the two containers to mix.

The construction of this device requires both filling and assembly of the two containers in an expensive cleanroom environment in order to ensure an acceptable cleanliness of the resulting product. Furthermore, if the sheet is by accident partly or completely pulled out through the aperture the substances of the two containers will mix instantly. This may be an issue if the stability of the mixture is much lower than the stability of each of the substances in isolation. For mixing devices intended for production of an administrable drug it will lead to a shorter time of expiry thereof.

### SUMMARY OF THE INVENTION

It is an object of the invention to provide a solution which eliminates, or at least reduces, drawbacks of the prior art.

In particular, it is an object of the invention to provide a medical device, wherein at least a portion of its interior is fluidly divided to maintain a sterile local environment.

It is a further object of the invention to provide such a device having access means for establishing fluid connection to a container, wherein the access means and/or a portion of a container closure is housed in a sterile environment until piercing of the container closure, and wherein no other barriers than the container closure needs be pierced by the access means.

It is an even further object of the invention to provide a medical device, where fluid can be withdrawn from a container without the user having to manually swab the container closure before penetration thereof.

It is an even further, object of the invention to provide a medical device which is easy to operate and which is suitable for being carried about in e.g. a pocket or a handbag.

In the disclosure of the present invention, aspects and embodiments will be described which will address one or more of the above objects and/or which will address objects apparent from the below disclosure as well as from the description of exemplary embodiments.

Thus, in a first aspect of the invention a medical device is provided comprising a frame defining an interior, a barrier element arranged to fluidly divide at least a portion of the interior, and barrier removal means connected with the barrier element and operable from an exterior of the frame to remove the barrier element from the interior through an opening in the frame.

A construction like this provides for easy removal of internally arranged barrier means in the device such that portions of the device interior may be fluidly separated until the user decides to combine them. The barrier element may e.g. be adapted to separate two gases, or a liquid from a gas.

Alternatively, or additionally, the barrier element may be adapted to prevent ingress of germs to a particular space within the device. In certain embodiments the barrier element is a sterilisation barrier, allowing the manufacturer to, during manufacturing, sterilise an interior portion of the device, or an element arranged in the interior of the device, separately and subsequently handle the sterilised portion or element outside clean room facilities, e.g. in connection with the assembly of the device. The sterilised interior portion or element may then be kept sterile until a first use of the device, where the barrier element is removed from the device interior and therefore prevented from interfering with any internal operations in the device.

In the present context, the term “sterilisation barrier” should be understood as a membrane, such as e.g. a foil or paper, capable of allowing passage therethrough of a sterilisation gas, while preventing passage of germs. The sterilisation barrier may be formed from a porous or a non-porous material, e.g. as described in WO 2009/056616 (Novo Nordisk A/S), the entire disclosure of which hereby being incorporated by reference.

The medical device may be a fluid transfer device capable of transferring a substance from one part of the device to another, e.g. for mixing with another substance. In that case, the medical device may further comprise a first container, e.g. a vial, adapted to hold first contents and access means suitable for establishing fluid communication between the first container and a second container, e.g. holding second contents. The access means may be arranged partially or fully in the interior of the device, and an interior portion of the access means may be fluidly separated from the first container by, at least, the barrier element. Further, the first container and/or the second container may be arranged at least partially in the interior of the device.

The barrier element may be removably secured to the access means, e.g. covering a penetration tool thereof, whereby the access means may be sealed and handled independently of other device components during manufacturing of the medical device.

The access means may comprise a single or dual spike construction, e.g. as known from a conventional type vial adaptor. Such a spike construction may comprise a perforated base portion supporting one or two hollow spikes, and one or two cylindrical sleeve members extending from the base portion and encircling the respective spikes. Alternatively, the access means may comprise a single- or double-ended needle mounted in a needle hub. The barrier element may be releasably mounted over the spike (or needle) or peelably secured to a circumferential rim of the sleeve member, in which case the spike (or needle) may be fully contained in a closed space defined by the barrier element, the sleeve member and the base portion (or needle hub). In some embodiments, a respective barrier element is peelably secured to each circumferential rim of the sleeve member, thereby providing a fluid tight local environment for both spike ends.

The barrier element may alternatively be removably secured to the first container, e.g. covering a penetrable section of a first container closure. Thereby, the exterior surface of the first container closure may be sterilised before assembly of the medical device, eliminating the need for manual swabbing before penetration thereof by the access means.

The barrier removal means may comprise a support structure removably arranged in the medical device interior and a grip portion connected with the support structure and arranged exteriorly of the frame. The support structure may be adapted to receive at least a portion of the barrier element, and the grip portion may be designed to provide an ergonomic grip, enabling easy extraction of the support structure from the device interior. The at least a portion of the barrier element may be secured to the support structure by welding or gluing, or by other suitable means.

In a second aspect of the invention a medical device is provided comprising a frame defining an interior, a first barrier element arranged to fluidly separate portions of the interior, a second barrier element arranged to fluidly separate other portions of the interior, and barrier removal means respectively connected with the first barrier element and the second barrier element and operable from an exterior of the frame to remove the first barrier element and the second barrier element from the interior through an opening in the frame.

The barrier removal means may comprise a support structure removably arranged in the medical device interior and a grip portion connected with the support structure and arranged exteriorly of the frame. At least a portion of the first barrier element may be attached to a first face, e.g. a distally oriented surface, of the support structure, and at least a portion of the second barrier element may be attached to a second face, e.g. a proximally oriented surface, of the support structure.

In the present context, the term “distally oriented” means facing the distal portion of the device, whereas the term “proximally oriented” means facing the proximal portion of the device. In principle, the terms “distal” and “proximal” normally indicate opposite portions of a device, where a distal portion is further away from the point of user operation than a proximal portion. In this context, however, the terms are merely used to specify two opposite directions.

The frame may comprise a) a housing structured to at least partially accommodate one or more of the first container, the second container and the access means, and b) a cap removably connectable with the housing via a cap receiving portion. The cap receiving portion may be translationally and rotationally locked with respect to the housing. The housing may be unitary or may comprise a number of interlocked elements.

The cap may comprise a first helical path and the cap receiving portion may comprise a mating second helical path, whereby the cap is capable of being dismounted from the cap receiving portion by relative rotation of the two.

The barrier removal means may be structured to prevent or limit cap motion relative to the cap receiving portion when the support structure is positioned in the device interior. For example, the cap may be rotatable about a general axis relative to the cap receiving portion, at least a portion of the opening in the frame may be provided in the cap and may be dimensioned to prevent relative rotation between the cap and the barrier removal means about the general axis when the support structure is positioned in the device interior, and the support structure may be locked against rotation about the general axis relative to the cap receiving portion, e.g. via an engagement with the housing.

Alternatively, or additionally, the cap may be translatable along the cap receiving portion, the opening in the frame may be provided entirely in the cap and may be dimensioned to limit or prevent relative translation between the cap and the barrier removal means when the support structure is positioned in the device interior, and the support structure may be locked against translation relative to the cap receiving portion, e.g. via an engagement with the housing.

By preventing the cap from moving relative to the cap receiving portion, or at least limiting its movements relative to the cap receiving portion, when at least a portion of the support structure is arranged in the interior, the barrier removal means may additionally serve as an activation lock for the medical device, ensuring that fluid communication between the first and second containers cannot be established before the user has manually pulled the support structure out through the opening.

The support structure may extend from the opening into the interior and may be rotationally and/or translationally fixated to the housing at an area opposite the opening to provide a stable arrangement of the barrier removal means.

In some embodiments the support structure and the grip portion are connected via a flexible portion arranged exteriorly of the opening. Thereby, the grip portion may be placed along or on the exterior frame surface during storage, reducing the transversal dimension of the medical device.

The fluid transfer device as described in connection with the exemplary embodiments of the present invention is particularly applicable for mixing liquids and for reconstituting a powder using a solvent. Non-exhaustive examples of drugs which may be provided in a powdered form include various factor products for use in the treatment of haemophilia, growth hormone, antibiotics and fertility drugs.

In the present specification, reference to a certain aspect or a certain embodiment (e.g. “an aspect”, “a first aspect”, “one embodiment”, “an exemplary embodiment”, or the like) signifies that a particular feature, structure, or characteristic described in connection with the respective aspect or embodiment is included in, or inherent of, at least that one aspect or embodiment of the invention, but not necessarily in/of all aspects or embodiments of the invention. It is emphasized, however, that any combination of features, structures and/or characteristics described in relation to the invention is encompassed by the invention unless expressly stated herein or clearly contradicted by context.

The use of any and all examples, or exemplary language (e.g., such as, etc.), in the text is intended to merely illuminate the invention and does not pose a limitation on the scope of the same, unless otherwise claimed. Further, no language or wording in the specification should be construed as indicating any non-claimed element as essential to the practice of the invention.

### BRIEF DESCRIPTION OF THE DRAWINGS

In the following the invention will be further described with references to the drawings, wherein

FIG. 1 shows a perspective view of a medical device according to an embodiment of the invention, in a pre-use state,

FIG. 2 shows a longitudinal section view of the device of FIG. 1,

FIG. 3 shows a close-up longitudinal section view of components of the device,

FIG. 4 shows a longitudinal section view of the device in an in-use state, and

FIG. 5 shows a perspective transverse section view of the device, detailing a pull tab installed therein.

In the figures like structures are mainly identified by like reference numerals.

### DESCRIPTION OF EXEMPLARY EMBODIMENTS

When in the following relative expressions, such as “downwardly” and “upwardly”, are used, these refer to the appended figures and not necessarily to an actual situation of use. The shown figures are schematic representations for which reason the configuration of the different structures as well as their relative dimensions are intended to serve illustrative purposes only.

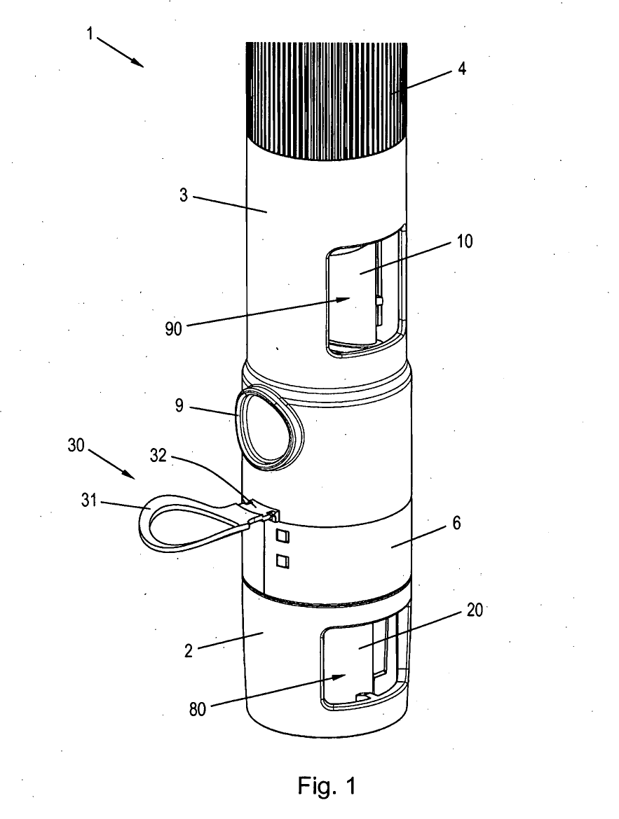

FIG. 1 is a perspective illustration of a medical device 1 according to an exemplary embodiment of the invention. The medical device 1 comprises a housing structure, in the form of a vial holder 2 and a lock ring 6, which accommodates a vial 20 holding a drug substance (not visible), which may e.g. be a powder or a fluid. The vial 20 is inspectable through a window 80. A removable cap 3 abuts the lock ring 6 along a circumferential interface, which is only interrupted by a notch in the cap 3, allowing passage of a pull tab 30 from an interior portion of the medical device 1 to the outside. The pull tab 30 has a grip ring 31, suited for being operated by a subject user, and a bendable section 32 which enables the grip ring 31 to be placed on a hanger 9 on the cap 3 during storage of the medical device 1. Thereby, a slender configuration of the packaging in which the medical device 1 is to be offered may be obtained.

The cap 3 covers a syringe 10 arranged opposite the vial 20. The syringe 10, which is inspectable through a window 90, carries a volume of a substance (not visible) adapted to be mixed with the drug substance in the vial 20. At its proximal end the cap 3 is provided with a furrowed section 4 which serves as a friction enhanced region offering the user a better grip when removing the cap 3 from the remaining parts of the medical device 1.

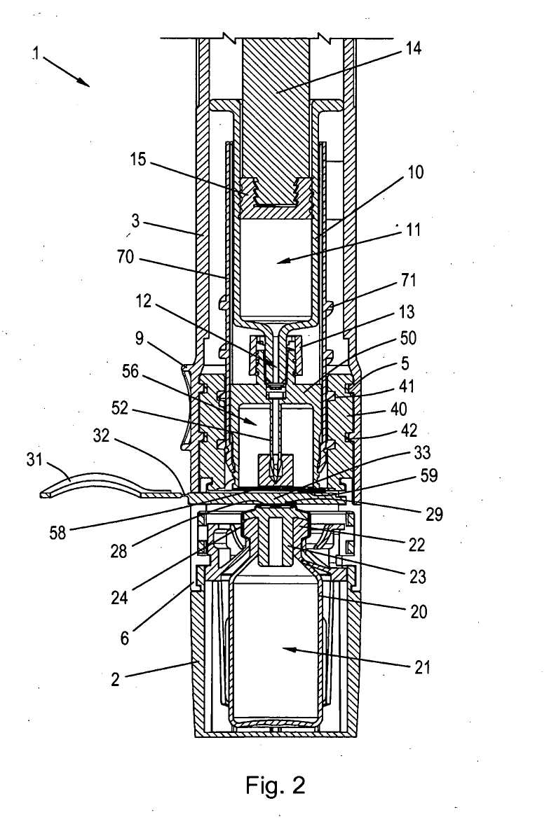

FIG. 2 is a longitudinal section view of the medical device 1 in a pre-use state, revealing its interior. The figure shows a co-axial alignment of the vial 20, the syringe 10, and a connector piece 50, which carries a hollow spike member 52 for establishment of fluid communication between a vial interior 21 and a syringe interior 11. The vial 20 is a conventional type of vial having a sealing vial stopper 23 arranged at its opening. The vial stopper 23 is attached to the vial 20 by a seal cap 24 being beaded onto an outwardly extending flange section 22. A barrier foil 28 covers a portion of the external surface of the vial stopper 23 which is sterilised by the manufacturer, e.g. by steam sterilisation, before assembly of the medical device 1. Thereby, an aseptic local environment is provided which does not have to be manually cleaned by the user.

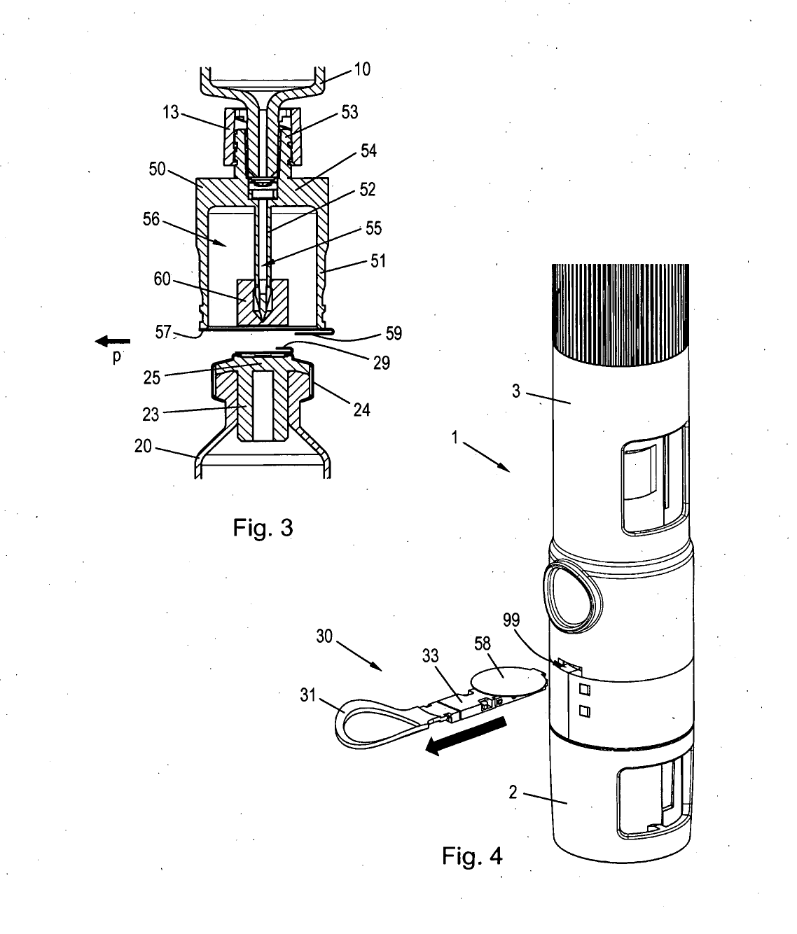

The connector piece 50 is described in more detail below with reference to FIG. 3. However, it can be seen from FIG. 2 that the spike member 52 is accommodated in an internal compartment 56 which is sealed by a barrier foil 58.

In the shown pre-use state of the medical device 1 the spike member 52 and the vial stopper 23 are spaced apart a certain axial distance which allows for the inclusion of a transversally extending support bar 33. The support bar 33 forms part of the pull tab 30 and is physically connected with the grip ring 31 via the bendable section 32. A flap 29 of the barrier foil 28 is secured to the downwardly oriented surface of the support bar 33, and a flap 59 of the barrier foil 58 is secured to the upwardly oriented surface of the support bar 33.

A coupling element 40 is axially and rotationally fixed to the lock ring 6 and provided with an exterior thread 42 for engagement with an interior thread 5 in the cap 3. The engagement between the exterior thread 42 and the interior thread 5 secures the cap 3 relative to the lock ring 6 and the vial holder 2. The coupling element 40 is further provided with an interior thread 41 adapted for engagement with an exterior thread 71 of a syringe holder 70 carrying the syringe 10.

The syringe 10 is mechanically coupled with the connector piece 50 via a Luer collar 13 and is fluidly connected with the spike member 52 via an outlet 12. A piston rod 14 is connected to a piston 15 and operable, after removal of the cap 3 from the coupling element 40, to pressurise the syringe interior 11.

The interior thread 41 and the exterior thread 42 are opposite, and the cap 3 is rotationally coupled with the syringe holder 70. Thereby, when the cap 3 is rotated in a dismounting direction relative to the coupling element 40 the syringe holder undergoes a rotation in the same direction, but whereas the cap 3 is consequently displaced axially upwards the syringe holder is displaced axially downwards, carrying with it the syringe 10 and the connector piece 50.

FIG. 3 is a close-up longitudinal section view of the connector piece 50 and the respective barrier foils 28, 58 in a pre-assembly condition where the pull tab 30 has not yet been installed. The connector piece 50 has a transversal spike base 54 carrying the spike member 52 and a threaded coupling piece 53 adapted for mating engagement with the Luer collar 13. The spike base 54 has a hollow central section which fluidly couples the outlet 12 and a lumen 55 in the spike member 52. An easily penetrable plug 60 is fitted onto the sharp end of the spike member 52 to prevent leakage therefrom during storage. It is emphasized, however, that an inclusion of such a plug is purely optional as the connector piece 50 and the fluid coupling with the syringe 10 can be designed in such a way that no fluid can leak therefrom before the device is operated in a use situation. A sleeve body 51 extends axially from the spike base 54, parallel, or substantially parallel, to the spike member 52 and terminates at a circumferential rim 57 to which the barrier foil 58 is attached, e.g. by a suitable adhesive or by welding. It is thereby possible for the manufacturer to sterilise the spike member 52, e.g. by steam sterilisation, through the seal before general assembly of the medical device 1. The connector piece 50 can thus be handled more easily, and with the barrier foil 28 being attached to the seal cap 24, e.g. by a suitable adhesive or by welding, and covering a penetrable section 25 of the vial stopper 23, the medical device 1 may be assembled outside clean room facilities.

In FIG. 3, the arrow, p, indicates the direction of the pull force that must be applied to the flaps 29, 59 in order to remove the barrier foils 28, 58 from, respectively, the rim 57 and the seal cap 24. The respective barrier foils 28, 58 may be made of the same material or of different materials. Non-exhaustive examples of suitable materials are e.g. aluminium and paper.

FIG. 4 is a perspective view of the medical device 1 in an in-use state where the pull tab 30 has been operated to remove the barrier foils 28, 58 from the interior of the medical device 1 through an opening 99 in the cap 3. For the sake of clarity the barrier foil 58 is shown on the support bar 33 in the configuration which it has before being peeled off the rim 57 of the connector piece 50 (and the barrier foil 28 is hidden under the support bar 33).

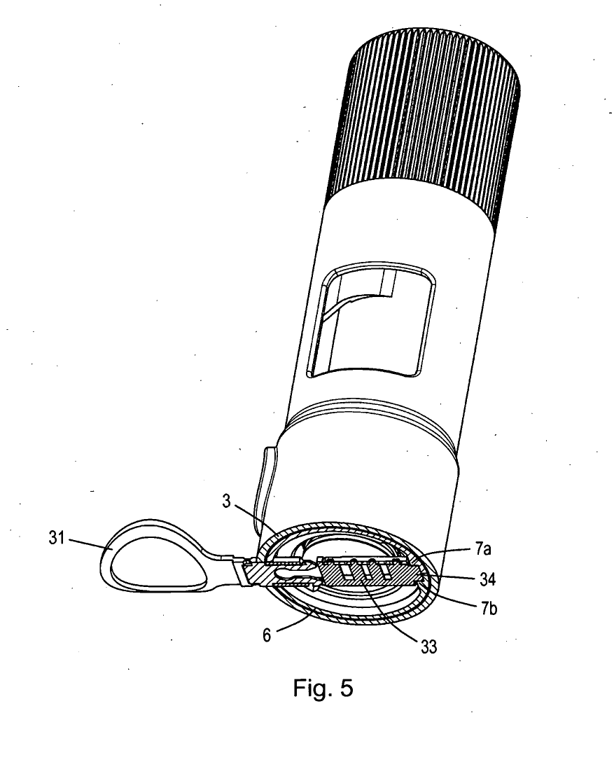

FIG. 5 is a perspective transverse section view of the cap 3 and the pull tab 30 in a pre-use state of the medical device 1. The support bar 33 comprises a protrusion 34 which is interposed between two abutment edges 7a, 7b on the lock ring 6 to stabilise the support bar 33 in the interior of the medical device 1. The engagement between the support bar 33 and the lock ring 6 locks the cap 3 against rotation relative to the lock ring 6. This serves as a safety feature preventing the cap 3 from being rotated relative to the coupling element 40 until the user removes the pull tab 30. Accidental rotation of the cap 3 may otherwise advance the spike member 52 towards the vial 20, due to the aforementioned opposite threads 41, 42, and thereby cause penetration of the barrier foils 58, 28 and undesired premature establishment of fluid connection to the vial 20.

In the following an operation of the medical device 1 will be described. FIGS. 1 and 2 display the medical device 1 after the user has lifted the grip ring 31 off the hanger 9. The rotational locks between the lock ring 6 and the coupling element 40 and between the cap 3 and the lock ring 6, due to the support bar 33, prevent the user from dismounting the cap 3 in this state of the medical device 1. To enable mixing of the contents of the syringe 10 and the vial 20 the user pulls the pull tab 30, whereby the support bar 33 is withdrawn from the interior of the medical device 1 through the opening 99. Since the barrier foils 28, 58 are secured to the support bar 33 via the respective flaps 29, 59 a transversally directed pull force will be exerted on the flaps 29, 59 during the withdrawal of the support bar 33 through the opening 99. This pull force will peel off the barrier foil 58 from the rim 57 and the barrier foil 28 from the seal cap 24, whereby the plug 60 and the penetrable section 25 will become exposed to one another.

Following removal of the pull tab 30 the user grabs the cap 3 by the furrowed section 4 and twists it relative to the vial holder 2 and the lock ring 6. This will cause the interior thread 5 to travel the exterior thread 42 in the upwards direction and the exterior thread 71 to travel the interior thread 41 in the downwards direction, due to the rotational coupling between the cap 3 and the syringe holder 70. During the downward motion of the syringe holder 70 the connector piece 50 is forced towards the vial 20 as a consequence of the axial connection between the coupling piece 53 and the Luer collar 13. At some point, the plug 60 will abut the vial stopper 23, whereafter further downward motion of the syringe holder 70 will force the spike member 52 to penetrate the plug 60 and, subsequently, the penetrable section 25. The plug 60 is adapted to slide axially along the spike member 52 during entry of the spike member 52 into the vial interior 21.

The threaded sections are designed such that when the interior thread 5 moves out of engagement with the exterior thread 42, and the cap 3 thereby can be removed, the spike member 52 has penetrated the vial stopper 23 and established fluid communication between the syringe interior 11 and the vial interior 21.

Upon dismounting of the cap 3 from the coupling element 40 the piston rod 14 is exposed for operation by the user. Pushing the piston rod 14 into the barrel of the syringe 10 will cause the piston 15 to pressurise the substance in the syringe interior 11 and force it out through the outlet 12, further through the lumen 55 and into the vial 20, where it will mix with the drug substance. The increased pressure in the vial 20 caused by the introduction of the substance from the syringe 10 exerts a backwards directed force on the piston rod 14 which, upon release of the piston rod 14 by the user, automatically transfers at least a sub-volume of the mixed product through the lumen 55 and into the syringe 10. The user may have to invert the medical device 1 and pull the piston rod 14 back manually an additional distance to empty the vial 20 (or rather minimise the volume of administrable drug therein). After transfer of the administrable drug product to the syringe 10 the Luer collar 13 is decoupled from the coupling piece 53 and the syringe 10 is ready for receiving a delivery element, such as e.g. a cannula or an infusion set, for administration of the drug.

The medical device 1 as described in the above removes the need for manual swabbing of external surfaces before mixing of the two substances, and thereby reduces the number of operational steps a user must carry out in order to prepare the drug for delivery, while offering a low effort fluid connection of the two containers.

1. A medical device comprising:
a frame defining an interior,
one or more barrier elements arranged to fluidly divide at least a portion of the interior,
barrier removal structure connected with the one or more barrier elements and operable from an exterior of the frame to remove the one or more barrier elements from the interior through an opening in the frame,
a first container adapted to hold first contents, and
a second container adapted to hold second contents,
characterised by further comprising access structure for establishing fluid communication between the first container and the second container, the access structure being arranged at least partially in the interior, and an inner portion of the access structure being fluidly separated from the first container at least by the one or more barrier elements.

2. A medical device according to claim 1, wherein the first container comprises a penetrable first container closure, and wherein the access structure is adapted to penetrate the first container closure.

3. A medical device according to claim 1, wherein one of the one or more barrier elements is removably secured to the access structure.

4. A medical device according to claim 2, wherein one of the one or more barrier elements is removably secured to the first container.

5. A medical device according to claim 4, wherein the one of the one or more barrier elements covers a penetrable section of the first container closure.

6. A medical device according to claim 1, wherein at least one of the one or more barrier elements is a sterilisation barrier.

7. A medical device according to claim 1, wherein the frame comprises a housing, and a cap removably connectable with the housing via a cap receiving portion.

8. A medical device according to claim 1, wherein the barrier removal structure comprises a support structure removably arranged in the interior and a grip portion connected with the support structure and arranged exteriorly of the frame, and wherein a respective portion of the one or more barrier elements is attached to the support structure.

9. A medical device according to claim 8, wherein the one or more barrier elements comprises a first barrier element and a second barrier element, and wherein a portion of the first barrier element is attached to a distally oriented face of the support structure, and a portion of the second barrier element is attached to a proximally oriented face of the support structure.

10. A medical device according to claim 8, wherein the frame comprises a housing, and a cap removably connectable with the housing via a cap receiving portion, wherein the cap comprises a first helical path, and the cap receiving portion comprises a second helical path adapted for mating engagement with the first helical path, and wherein the barrier removal structure is adapted to lock the cap against rotation relative to the cap receiving portion, when the support structure is positioned in the interior.

11. A medical device according to claim 10, wherein the cap is rotatable about a general axis relative to the cap receiving portion, wherein at least a portion of the opening is arranged in the cap and is dimensioned to prevent relative rotation between the cap and the barrier removal structure about the general axis, when the support structure is positioned in the interior, and wherein the support structure is locked against rotation about the general axis relative to the cap receiving portion.

12. A medical device according to claim 10, wherein the support structure extends from the opening into the interior and is rotationally fixated to the housing at an area opposite the opening.

13. A medical device according to claim 8, wherein the support structure and the grip portion are connected via a flexible link arranged exteriorly of the opening.
